(19) United States
(12) Patent Application Publication
(10) Pub. No.: US 2026/0205492 A1
(43) Pub. Date: Jul. 16, 2026

(54) MEASURES OUTPUT METHOD, MEASURES OUTPUT DEVICE, AND RECORDING MEDIUM

(71) Applicant: Panasonic Automotive Systems Co., Ltd., Kanagawa (JP)

(72) Inventors: Teruyoshi HASEGAWA, Hyogo (JP); Hiroyuki WADA, Kyoto (JP); Yusuke NEMOTO, Hyogo (JP); Toru IWANO, Osaka (JP)

(73) Assignee: Panasonic Automotive Systems Co., Ltd., Kanagawa (JP)

(21) Appl. No.: 19/346,992

(22) Filed: Oct. 1, 2025

(30) Foreign Application Priority Data
Oct. 30, 2024 (JP) 2024-191218

(51) Int. Cl. H04L 9/40; H04L 9/08; H04L 9/30; H04L 9/32

(52) U.S. Cl. CPC H04L 63/1441; H04L 63/1416; H04L 9/0852; H04L 9/3066; H04L 9/3249

(57) ABSTRACT

A measures output method is to be executed by a computer. The measures output method includes: obtaining respective importance levels of a plurality of partitions for separating a plurality of functional sections to be mounted on a vehicle, the plurality of functional sections including a first partition to which a first functional section at a source belongs, and a second partition to which a second functional section at a destination belongs; determining a security measure for a communication from the first functional section to the second functional section based on a first importance level of the first partition and a second importance level of the second partition; and outputting information on the security measure determined.

### CROSS REFERENCE TO RELATED APPLICATION

The present application is based on and claims priority of Japanese Patent Application No. 2024-191218 filed on Oct. 30, 2024.

### FIELD

The present disclosure relates to a measures output method, a measures output device, and a recording medium.

### BACKGROUND

Patent Literature (PTL) 1 discloses calculating a risk value using a technical element in an analysis target system including data handled by the system, extracting the importance level of the facility related to a corresponding attack scenario for a threat indicating a risk value greater than a reference value, and selecting security measures in the number corresponding to the importance level of this facility.

### CITATION LIST

### Patent Literature

PTL 1: Japanese U.S. Pat. No. 7,213,626

### SUMMARY

A measures output method, and so on, can be improved upon.

To meet the demand, the present disclosure provides a measures output method, and so on, capable of improving upon the above related art.

A measures output method according to an aspect of the present disclosure is to be executed by a computer. The measures output method includes: obtaining respective importance levels of a plurality of partitions for separating a plurality of functional sections to be mounted on a vehicle, the plurality of partitions including a first partition to which a first functional section at a source belongs, and a second partition to which a second functional section at a destination belongs; determining a security measure for a communication from the first functional section to the second functional section based on a first importance level of the first partition and a second importance level of the second partition; and outputting information on the security measure determined.

A measures output device according to an aspect of the present disclosure includes: an obtainer that obtains respective importance levels of a plurality of partitions for separating a plurality of functional sections to be mounted on a vehicle, the plurality of partitions including a first partition to which a first functional section at a source belongs, and a second partition to which a second functional section at a destination belongs; a determiner that determines a security measure for a communication from the first functional section to the second functional section based on a first importance level of the first partition and a second importance level of the second partition; and an output unit that outputs information on the security measure determined.

A recording medium according to an aspect of the present disclosure is a non-transitory computer-readable recording medium having recorded thereon a program for causing a computer to execute the measures output method described above.

According to an aspect, the present disclosure can achieve a measures output method, and so on, capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a block diagram showing a functional configuration of a measures output device according to an embodiment.

FIG. 2 shows example property information according to the embodiment.

FIG. 3 shows an example control measures policy according to the embodiment.

FIG. 4 shows an example control measures DB according to the embodiment.

FIG. 5 is a flowchart showing an operation to be executed by the measures output device according to the embodiment.

FIG. 6 shows an example table showing the correspondence between the total SFOP values and importance levels according to the embodiment.

FIG. 7 is for illustrating calculation of risk values in view of the importance levels according to the embodiment.

FIG. 8 is for illustrating determination on security measures by the measures output device according to the present disclosure.

### DESCRIPTION OF EMBODIMENT

### Circumstances Leading to the Present Disclosure

Prior to the description of the present disclosure, the circumstances leading to the present disclosure and the features of the present invention will be described.

In the future, as revolution of on-vehicle architecture, the progress of integration of gateways (GWs), domains, and high-performance computing (HPC) is expected. An increasing number of vehicles that dynamically update software as software-defined vehicles (SDVs) and provide new values are also expected. This is not limited to vehicles and believed to apply to other objects capable of communications with the outside. Note that the vehicles may be manual driving vehicles or autonomous driving vehicles. The vehicles may be electric vehicles (EVs) or gasoline vehicles.

Here, typical vehicle security architectures are mainly employed in perimeter defense or multi-layer defense. In this case, main measures are set on an item boundary, assuming no unauthorized intrusion. The boundary to be protected becomes however ambiguous due to the integration and an increasing number of attack interfaces and the typical vehicle security architectures have insufficient security measures in more cases. Specifically, target systems are required to output more suitable security measures.

On the other hand, while a zero trust architecture (ZTA) is considered in the IT industry, introducing a ZTA to vehicles and other objects requiring real-time performance raises concerns about the real-time performance, costs, and other problems.

To address the problems, the present inventors have earnestly studied a measures output method, and so on, capable of outputting more suitable security measures and conceived of the following measures output method, and so on. For example, the present inventors have conceived of a measures output method, and so on, capable of outputting security measures assuming unauthorized intrusion.

Here, as an alternative architecture to ZTA, a new on-vehicle architecture is being considered (e.g., studied in Multiple Independent Levels of Security (MILS)) in which each function within the item boundary is divided into specific partitions. Such a new on-vehicle architecture is based on the idea of trusting the inside of the partition and not trusting the outside of the partition (e.g., between partitions). There is thus a risk when crossing partitions (in case of communications between partitions) and security measures, such as function separation, are required. Note that the partitions will be described later. The MILS may be introduced, for example, in the design phase of the vehicle specifications.

For example, the measures output method, and so on, according to the present disclosure includes: setting the respective importance levels of the partitions based on the influence of the SFOP on the information properties handled in the partitions and other factors, and determining a most suitable security measure based on the respective importance levels of the two partitions (e.g., the difference in importance level) to which the functional sections, such as an electronic control unit (ECU) executing exchange of information, belong. Accordingly, the measures output method, and so on, can set security measures according to the importance level (e.g., the difference in importance level) between the partitions, assuming unauthorized intrusion, and output the set security measure as the more suitable security measure. The influence of the SFOP includes information on in which direction the property influences, for example, the degree of influence (e.g., the damage impact) when the properties are falsified. For example, the higher the degree of influence of the SFOP, the higher value may be set to the importance level.

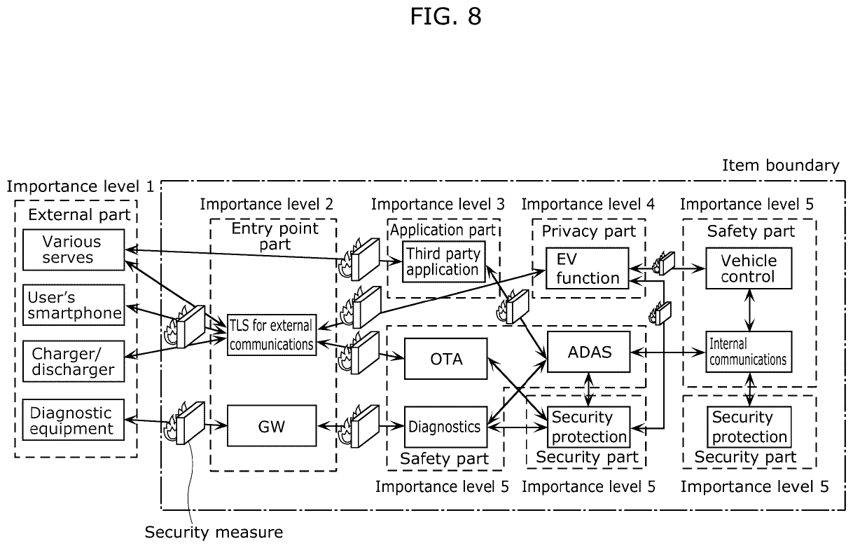

Here, the partitions and the importance levels in the measures output method according to this embodiment will be described with reference to FIG. 8. FIG. 8 is for illustrating determination on a security measure in a measures output device according to the present disclosure. FIG. 8 shows an example where the measures output device according to the present disclosure sets respective importance levels to the partitions and determines and mount the security measures according to the difference in importance level between the partitions. The item boundary represents the boundary between the inside and outside of the vehicle.

The partitions shown in FIG. 8 are set in advance based on partition information obtained from an external device. The partitions include an external part outside the vehicle; and an entry point part, an application part, a privacy part, a safety part, and a security part inside the vehicle. Note that the partitions shown in FIG. 8 are mere examples and not limited thereto.

The external part is a partition to which an external device of the vehicle belongs. Examples include “Various servers”, “User's smartphone”, “Charger/discharger”, and “Diagnostic equipment”. “Importance level 1” is set to the external part by an importance level setter which will be described later.

The entry point part is a partition to which a functional section belongs, which communicates with external devices (e.g., wireless communications). Examples include functional section for transport layer security “(TLS) for external communications” and “GW”. “Importance level 2” is set to the entry point part by the importance level setter.

The application part is a partition to which a functional section belongs, which is related to an application (e.g., an application installed by the user and the function thereof is added) different from the application (i.e., the system application) pre-installed in the vehicle. Examples include a functional section for executing a “Third party application”. “Importance level 3” is set to the application part by the importance level setter.

The privacy part is a partition to which the functional section related to the privacy belongs. Examples include the functional section for “EV function”. “Importance level 4” is set to the privacy part by the importance level setter.

The safety part is a partition to which the functional section related to the vehicle safety belongs. For example, there are: partitions including functional sections for “Diagnostics” (i.e., the self-diagnostic function), Over-the-Air (“OTA”) and advanced driver-assistance system (“ADAS”); and partitions including functional sections for “Vehicle control” and “Internal communications”. “Importance level 5” (e.g., the maximum value) is set to the privacy part by the importance level setter.

The security part is a partition to which the functional section related to the vehicle security belongs. Examples include the functional section for “Security protection”. “Importance level 5” is set to the security part by the importance level setter.

In this manner, the present disclosure sets the respective importance levels to the partitions.

In communications between functional sections, the measures searching processor, which will be described later, determines the security measure, based on the two importance levels (here the difference between the two importance levels) set to the respective partitions to which the functional sections belong.

Now, the embodiment will be described in detail with reference to the drawings. Specifically, the measures output method, and so on, capable of determining a security measure in communications between functional sections, based on the difference in importance level as shown in FIG. 8 will be described with reference to the drawings.

The embodiment described below is a mere comprehensive or specific example. The numerical values, shapes, elements, the arrangement and connection of the elements, steps, step orders etc. shown in the following embodiment are thus mere examples, and are not intended to limit the scope of the present disclosure. Among the elements illustrated in the following embodiment, those not recited in the independent claims will be described as optional.

The same reference signs represent substantially the same configurations in the drawings and redundant description will be omitted or simplified.

In this specification, the terms representing the relationships between the elements, the numerical values, and the numerical ranges do not only have the exact meaning but include substantially equivalent ranges, such as errors of percentages (or about 10%).

In this specification, unless otherwise noted, the ordinal numbers, such as “first” and “second”, do not indicate the numbers or order of the elements but are used to distinguish the elements of the same type from each other, while avoiding confusion.

### Embodiment

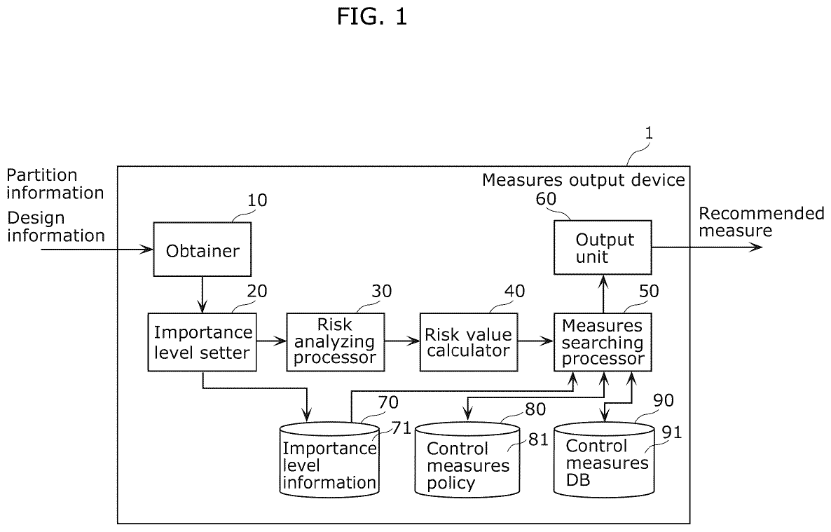

Now, a measures output method, and so on, according to this embodiment will be described with reference to FIGS. 1 to 8.

### 1. Configuration of Measures Output Device

First, a configuration of a measures output device for executing the measures output method according to this embodiment will be described with reference to FIGS. 1 to 4. FIG. 1 is a block diagram showing a functional configuration of measures output device 1 according to this embodiment. Note that FIG. 1 shows an example functional configuration of measures output device 1, which is not limited to what is shown in FIG. 1.

As shown in FIG. 1, measures output device 1 includes obtainer 10, importance level setter 20, risk analyzing processor 30, risk value calculator 40, measures searching processor 50, output unit 60, first storage 70, second storage 80, and third storage 90. Measures output device 1 also includes a processor and a memory as hardware. Examples of the memory may include a read-only memory (ROM) and a random-access memory (RAM) that can store programs to be executed by a processor. The functions of measures output device 1 are fulfilled by the processor, for example, for executing the programs stored in the memory. Measures output device 1 may be achieved by a desk top personal computer (PC), a mobile terminal, such as a smartphone or a tablet, a server device, or any other suitable device, alone or in combination.

Obtainer 10 is a communication interface that obtains various information for outputting security measures in a vehicle. Obtainer 10 obtains partition information and design information through communications. Obtainer 10 may include a communications circuit (or a communication module), for example. While obtaining various information through wireless communications, obtainer 10 may obtain various information through wired communications.

The partition information includes the information on a plurality of partitions for separating a plurality of ECUs to be mounted on the vehicle or the functions thereof. The plurality of partitions include a first partition and a second partition. The partition information includes the information identifying the plurality of partitions, the information identifying the respective ECUs belonging to the partitions, or other information. The ECUs are an example of the “functional sections”.

Here, the ECUs are each an on-vehicle ECU that is to be mounted on a vehicle and executes the control of vehicle devices included in the vehicle. Examples of the ECU include a processor (e.g., a microprocessor), a digital circuit, such as a memory, an analog circuit, and a communication circuit. The memory is a ROM or a RAM, for example, and can store control programs (i.e., computer programs) to be executed by the processor. For example, the processor operates in accordance with the control programs (i.e., the computer programs) so that the ECUs fulfil various functions. These control programs include a third party application, for example, shown in FIG. 8.

The ECUs may be each an ECU (what is called a “zone ECU”) that controls a vehicle device or may be a central ECU (what is called a “integrated ECU”) obtained by integrating a plurality of ECUs. The integrated ECU is obtained by integrating the functions divided into and mounted on a plurality of typical ECUs to solve the problems of the development period and costs increasing in accordance with the complication of an on-vehicle system (i.e., an example of the “target system”). The integrated ECU employs the virtualization technology for operating a plurality of visual computers (i.e., visual machines (VMs)) in one ECU. In this manner, one ECU may have a plurality of functions. In this case, the plurality of functions fulfilled by the one ECU is an example of the “functional sections”.

The partitions serve as the boundaries between the reliable and unreliable areas of the data or process forming the functions of the associated ECUs, and are set by a designer, for example.

Here, the functions of the ECUs can be said to be properties held by the ECUs, that is, the ECUs'“holding properties”. In the field of security, the holding properties may be divided into the four perspectives of the SFOP, namely, the safety, finance, operations, and privacy (i.e., personal information). Example of the holding properties related to the “safety” include the vehicle driving function and the power supply function. These holding properties correspond to the functions of the ECUs related to an automobile, and eventually the safety of the occupant(s). Example of the holding properties related to the “finance” include the automobile itself and loads. These holding properties are protected by locking the windows and doors of the automobile, for example. The holding properties related to the “finance” correspond to the functions of the ECUs related to such locking. Example of the holding properties related to the “operations” include applications mounted on the ECUs. The holding properties related thereto correspond to the functions of the ECUs with such applications to be mounted thereon. Example of the holding properties related to the “privacy” include the driving records of the automobile, videos and sounds captured by an on-vehicle camera. The holding properties related thereto correspond to the functions of the ECUs that records data, such as the driving records.

The “holding properties” include not only tangible properties held as the functions held by functional sections, such as ECUs (hereinafter simply referred to as “ECUs”), the functions or data held by the ECUs, and the software itself mounted on the ECUs.

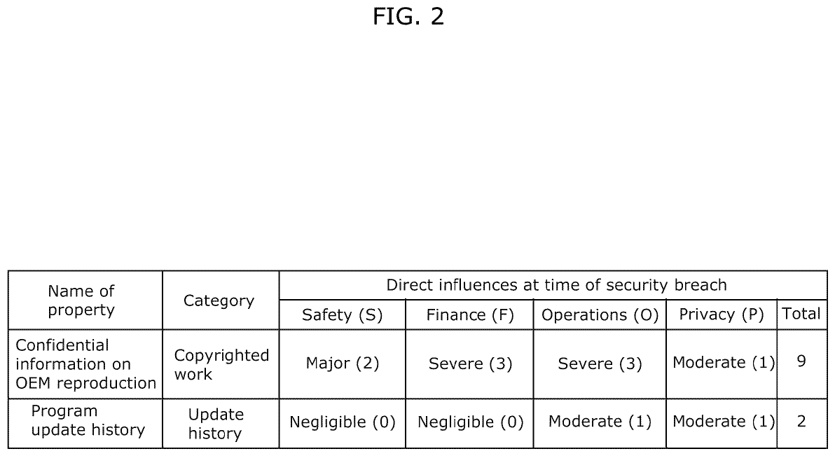

The partition information may include property information indicating such holding properties of the ECUs. The property information will be described with reference to FIG. 2.

FIG. 2 shows example property information according to this embodiment.

As shown in FIG. 2, the property information includes the “Name of property”, “Category”, and information on “Direct influences at time of security breach”.

The “Name of property” is for identifying a property. Examples include “Confidential information on original equipment manufacturing (OEM) reproduction”, and “Program update history”.

The “Category” is of each property. Examples include copyrighted work and the update history.

The information on “Direct influences at time of security breach” indicates the influences on the properties in terms of SFOP, that is, the degree of the influence (e.g., SFOP values) of the infringement in unauthorized use of the properties. The information includes the degrees of the influences in terms of the safety, finance, operations, and privacy. In the example shown in FIG. 2, four degrees of the influence, namely, “Severe (3)”, “Major (2)”, “Moderate (1)”, and “Negligible (0)” are used. The number of degrees is not particularly limited as long as being two or more.

The “Total” represents the sum of the degrees of influence in terms of the safety, finance, operations, and privacy.

The design information is also called “vehicle design information”, and includes information at the time of designing the on-vehicle system mounted on the vehicle. Examples of the design information include identification information on the ECUs, the information indicating the connection relation between ECUs, and the information, such as the version, on software. The design information is used to generate an attack scenario which will be described later. Examples of the information indicating the connection relation may include arrangement information on the ECUs within the on-vehicle system, and the information indicating the communication paths of the ECUs. Note that the communication paths may include physical connections and paths integrated (or deemed to be one) by a logical session.

Based on the detailed properties (i.e., the SFOP) held by one or more functional sections within each of the plurality of partitions, importance level setter 20 sets one of the importance levels for the partition. The importance levels may include two or more levels which may be numerical values, such as one to five, or stages such as, “high”, “medium”, and “low”. Importance level setter 20 causes first storage 70 to store importance level information (e.g., importance level information 71 shown in FIG. 1, which will be described later) indicating the respective importance levels of the partitions. In this embodiment, importance level setter 20 obtains the respective importance levels of the partitions by setting the importance levels. Importance level setter 20 is an example of an “obtainer that obtains respective importance levels”.

Note that importance level setter 20 may set the importance level of the external part shown in FIG. 8. Importance level setter 20 may set the importance level of the external part, based on connection characteristics (e.g., remote wireless communications (long-distance wireless communications), proximity wireless communications (short-distance wireless communications)) of the communications between the entry ECU and an external device. Importance level setter 20 may set a higher importance level to remote wireless communications than to proximity communications.

The remote wireless communications mean the wireless communications that can cover the communication distances of hundreds of meters to kilometers. Examples include communications under IEEE 802.11ah. The proximity wireless communications mean the wireless communications within communication distances of tens of meters. Examples include communications through the ZigBee (registered trademark), the Bluetooth (registered trademark), and a wireless local area network (LAN).

Risk analyzing processor 30 generates attack scenarios for the properties, based on the design information. The attack scenarios indicate which property may be attacked in which way, and include the attack paths and the possible properties to be attacked. The attack paths include the intrusion path (i.e., the communication path) from the ECU (i.e., the “entry ECU”) at the entry point (i.e., the entry point from the outside) to the ECU (i.e., the “target ECU”) at the attack target point for achieving the threat scenario. A scenario that can be a threat indicating the ways of attack. Examples may include unauthorized access to predetermined information, falsification in the control of the ADAS, and other scenarios that could be a threat for the vehicle safety or other confidentialities. Based on the attack path, through which ECU (e.g., which partition in this embodiment) is to be passed to reach the “target ECU” from “entry ECU” can be grasped. The priorities to be attacked represents the priorities that can be attacked for achieving a threat scenario. Examples include predetermined information and predetermined software.

Risk analyzing processor 30 may analyze the vulnerabilities according to the attack scenarios. The vulnerabilities can be analyzed based on, for example, the fact whether the software of the ECUs included on the attack path is vulnerable, the number of the ECUs (i.e., the stages) included in (e.g., passing through) the attack path, and defects in the security policy. Whether software is vulnerable can be determined based on the version of the software, the information indicating the vulnerabilities found in the software, or other information. The defects in the security policy can also be determined based on the version of the security policy.

Risk value calculator 40 calculates the risk value, which is an index indicating a possibility of being attacked, in each attack scenario. That is, risk value calculator 40 calculates one risk value in one attack scenario. Risk value calculator 40 calculates the risk value of each attack scenario, based on at least one of the number of stages from the entry ECU to the target ECU, the circumstances of the already implemented security measure, the connection characteristics when the entry ECU communicates with an external device, the fact whether the ECUs on the attack path are vulnerable, or other factors. The risk value calculated based on the at least one of the factors corresponds to a risk value calculated as usual or is also referred to as a “feasibility value”.

For example, if there a smaller (e.g., smaller than a predetermined number) number of intermediate ECUs, if the ECUs on the attack path are vulnerable, or under remote wireless communications, a higher risk value is calculated. While how to calculate the risk values is not particularly limited, any know method is applicable. The risk value is not necessarily a numerical value but may be a gradual level, such as, “high”, “medium”, or “low”. The risk value is an example of the “risk level”.

The calculated risk value is used by measures searching processor 50 to determine whether to execute the process of determining a security measure.

While the details will be described later, risk value calculator 40 may calculate the risk value, further based on an importance level. For example, risk value calculator 40 may calculate the risk value of the attack scenario, based on the importance level of at least one of the one or more partitions belonging to the one or more ECUs included in the attack scenario.

Measures searching processor 50 determines the security measure to be executed in the communications between ECUs belonging to different partitions. Measures searching processor 50 determines the security measure based on the respective importance levels of two partitions to which the ECUs under communications belong. In this embodiment, measures searching processor 50 determines the security measure based on the difference in importance level between the two partitions. In other words, measures searching processor 50 uses the difference in importance level between the two partitions as a material for determining the security measure. Measures searching processor 50 may use control measures policy 81 and control measures database (DB) 91, which will be described later, to determine the security measure. Measures searching processor 50 is an example of the “determiner that determines the security measure”.

The determination on the security measure based on the difference in importance level allows the user to grasp the communications between which ECUs the importance needs to be put. For example, the user can grasp that the larger the difference, the more importance needs to be put on the security measure in the communications. The larger the difference, the security measure with the higher security level is determined so that the levels of the security measure are variable. Accordingly, the security measures are executed efficiently. In addition, the amount of the processing by the information processor for executing the security measures can be reduced as compared to the case of setting a unique security measure.

Note that measures searching processor 50 determines no security measure for communications between the functional sections within the same partition. For example, in FIG. 8, no security measure is provided for the communications between “Vehicle control” and “Internal communications” and between “Diagnostics” and “ADAS”. A security measure or no security measure may be determined for the communications between the functional sections belonging to the partitions with the same importance level. For example, in FIG. 8, a security measure or no security measure may be provided for the communications between “Diagnostics” and “Security protection”, “OTA” and “Security protection”, “ADAS” and “Security protection”, and between “Internal communications” and “security protection”.

Output unit 60 is a communications interface that outputs the information on the security measure determined by measures searching processor 50, as a recommended measure. For example, output unit 60 may include a communication circuit (or a communication module). The information on the security measure may include the information indicating the detailed security measure.

Output unit 60 may send the information on the security measure to a terminal device and cause the user to present the security measure. Output unit 60 may sending the information on the security measure to a device in an on-vehicle network, which is mounted on the vehicle, and to cause the device to execute the security measure. While outputting the security measure through wireless communications, output unit 60 may output the security measure through wired communications.

Note that output unit 60 may include a presentation device and present the information including a security measure to the user through the presentation device. The presentation device may be a display device including a liquid crystal panel, a sound emitting device, such as a speaker, or any other suitable device.

First storage 70 is a storage device that stores importance level information 71.

Second storage 80 is a storage device that stores control measures policy 81. Control measures policy 81 represents a rule how to use an importance level to determine a security measure. For example, the security measure according to the difference in importance level is determined under control measures policy 81.

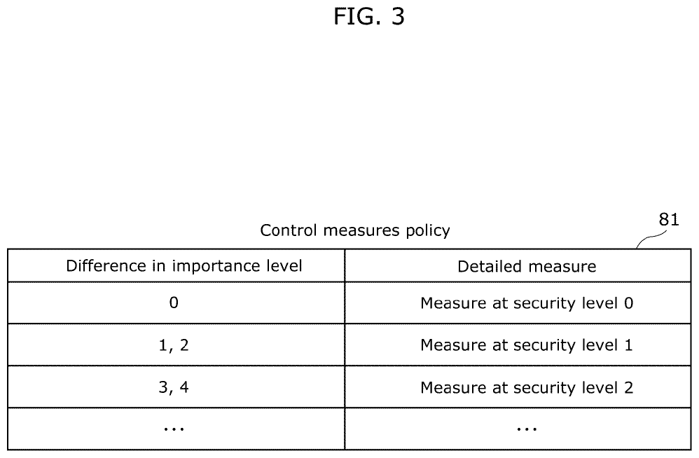

FIG. 3 shows example control measures policy 81 according to this embodiment. Note that the values of the security levels shown in FIG. 3 represent the relative relation between security levels. “0” indicates the lowest security level. The greater the numerical value, the higher the security level.

As shown in FIG. 3, control measures policy 81 represents the correspondence between the differences in importance level and the detailed measures. Specifically, control measures policy 81 represents the correspondence between the differences in importance level and the security levels of the detailed measures. The security level is an index indicating the degree of security (safety) according to the security measure. The safer, the higher security level is expressed. In the example shown in FIG. 3, with the difference “0” in importance level, the measure at security level 0 is associated. With the difference of “1” or “2” (i.e., an example of the “first value”) in importance level, the measure at security level 1 is associated. With the difference “3” or “4” (i.e., an example of the “second value”) in importance level, the measure at security level 2 is associated. For example, control measures policy 81 may include that, if the difference in importance level is the second value that is larger than the first value, the associated security level is higher than the security level associated with the first value.

Control measures policy 81 may include at least one of the following in addition to what is shown in FIG. 3. Examples of control measures policy 81 may include the following. Authentication may be performed between processes in data communications when there is a difference in importance level. Sanitization or filtering of input data may be performed at the receiver in data communications from a partition with a lower importance level to a partition with a higher importance level. Data may be encrypted or a signature may be put at the sender in data communications from a partition with a higher importance level to a partition with a lower importance level. The signature is put to check whether the data is transferred without being falsified (i.e., to secure the completeness). Examples of control measures policy 81 may also include data separation in a memory or mandatory access control (MAC) of resources when ECUs under communications are mounted in the same CPU under access control where there is a difference in importance level.

Examples of control measures policy 81 may include the following. All the communication logs may be recorded and a resilience function at the time of anomaly detection may be mounted, if the importance level is higher than or equal to the first level (e.g., 4 or more). Secure Root of Trust (RoT) may be secured by secure boot or dynamic falsification detection using a hardware security module (HSM), if the importance level is the second level (e.g., 5 or more). Examples of control measures policy 81 may include setting (or resetting) the respective importance levels of the partitions so that the importance levels or the differences in importance levels of the partitions at the start and the goal of the communication path are the same, if the importance level is higher than or equal to the third level (e.g., 4 or more). For example, the following first and second security measures may have the same security level, that is, employ the same algorithm. The first security measure is executed when information is output from the ECU at the entry point to another ECU belonging to the first partition, or when information is output from an external device to this ECU. The second security measure is executed when information is output from another ECU belonging to the second partition to the ECU at the target point. Accordingly, for example, if a measure of putting a signature is executed as the first security measure, the signature can be verified as the second security measure, which can improve the security performance effectively.

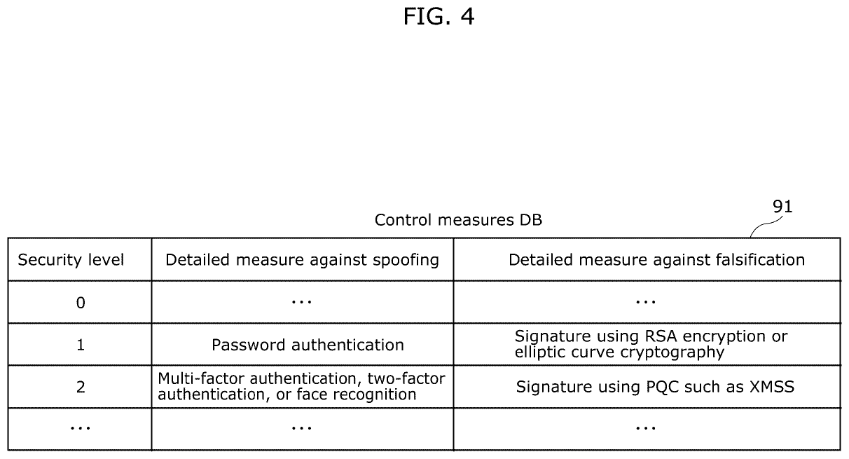

Referring back to FIG. 1, third storage 90 is a storage device that stores control measures DB 91. Control measures DB 91 include candidate security measures. An example of control measures DB 91 will be described with reference to FIG. 4. FIG. 4 shows an example of control measures DB 91 according to this embodiment.

As shown in FIG. 4, control measures DB 91 is a table showing the correspondence among the security levels, the detailed measures against spoofing, and the detailed measures against falsification.

The “detailed measures against spoofing” are the detailed security measures for reducing the spoofing of an ECU included in an on-vehicle system and a fraudulent process, such as outputting fraudulent information executed by a malicious third party. The “detailed measures against spoofing” are different from security level to security level. Examples of the detailed measures at the security level “1” include password authentication. Examples of the detailed measures at the security level “2” include multi-factor authentication, two-factor authentication, or face recognition, but are not limited thereto. Note that a higher security level in authentication may mean that the authentication requires a larger amount of processing.

The “detailed measures against falsification” are the detailed security measures for reducing falsification of properties (e.g., information), which are held by an ECU, by a malicious third party. The “security measures for reducing falsification” are different from security level to security level. Examples of the detailed measures at the security level “1” include a signature using RSA encryption or elliptic curve cryptography. Examples of the detailed measures at the security level “2” include a signature using post-quantum cryptography (PQC), such as the eXtended Merkle Signature Scheme (XMSS). The measures are not limited thereto. Note that a security level in falsification means how difficult the ciphertext is to decipher. A higher security level may mean that the encryption key has a larger number of bits (i.e., a greater length). The higher the security level, a security measure requiring the larger amount of information processing and the more costs may be determined so as to be executed.

In this manner, control measures DB 91 includes the detailed measures different from security level to security level. In other words, control measures DB 91 includes the detailed measures different in accordance with the differences in importance level. Even if the security level is “0”, that is, the difference in importance level is “0”, the detailed measures may be set. The “detailed measures different from security level to security level” means that at least the qualities of the security measures are different from security level to security level.

Note that one security measure or a plurality of security measures may be determined for one difference in importance level based on FIG. 4. Based on FIG. 4, at least one of the detailed measures against spoofing or the detailed measures against falsification may be determined for one difference in importance level.

Note that control measures DB 91 may be a table showing not necessarily the correspondence between the security levels (i.e., an example of the “value according to the difference in importance level”) and the detailed measures. The table may show the correspondence between the differences in importance level (i.e., an example of the “value according to the difference in importance level”) and the detailed measures. Control measures DB 91 may include the detailed measures against cyber-attacks other than spoofing and falsification.

Examples of first to third storages 70 to 90 include a non-volatile storage device (e.g., a solid state drive (SSD) or a hard disk drive (HDD)). The storages are however not limited thereto. First to third storages 70 to 90 may be achieved by one storage device but may be separate storage devices.

### 2. Operation of Measures Output Device

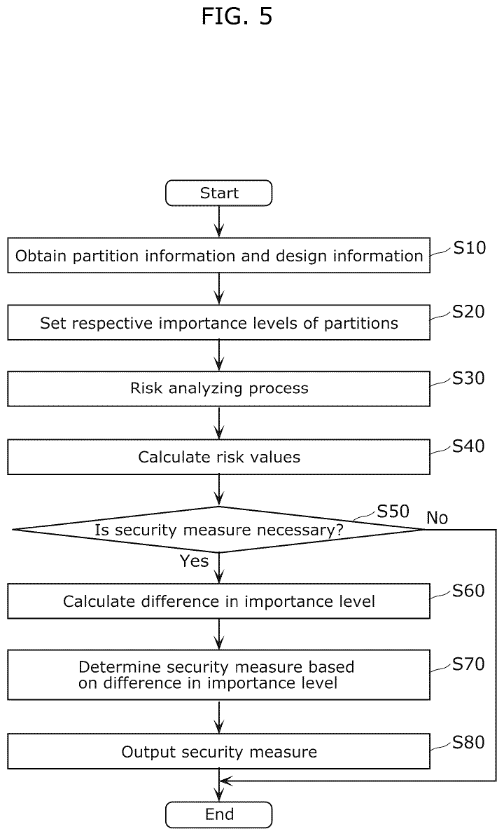

Now, an operation of measures output device 1 configured as above will be described with reference to FIGS. 5 to 8. FIG. 5 is a flowchart showing an operation (i.e., a measures output method) to be executed by measures output device 1 according to this embodiment. That is, the measures output method shown in FIG. 5 is executed by a computer.

As shown in FIG. 5, first, obtainer 10 obtains partition information and design information (S10). The time when obtainer 10 obtains the partition information and the design information is not particularly limited. Obtainer 10 may cause a storage (not shown) included in measures output device 1 to store the partition information and the design information.

Next, importance level setter 20 sets the respective importance levels of the partitions (S20). Importance level setter 20 sets the respective importance levels of the partitions defined by the partition information, based on the detailed properties (see, e.g., FIG. 2) included in the partition information.

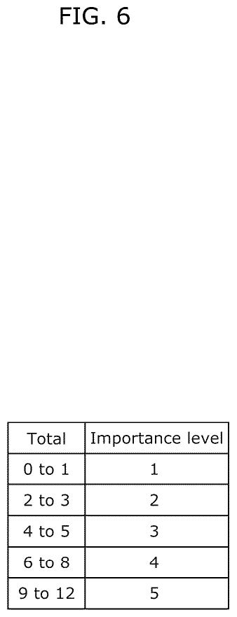

Here, the process of setting the importance levels by importance level setter 20 will be described with reference to FIG. 6 in addition to FIG. 2. FIG. 6 shows an example table showing the correspondence between the total SFOP values and the importance levels according to this embodiment. The table may be, for example, included in the partition information and obtained, or stored in advance in a storage of measures output device 1. Note that FIG. 2 shows properties held in the partition “safety part”. Now, an example of how importance level setter 20 sets the importance level of the “safety part” will be described.

Importance level setter 20 calculates one SFOP value associated with the partition, based on the SFOP values of the properties held within the partition. In the example shown in FIG. 2, importance level setter 20 may calculate one SFOP value associated with the “safety part”, based on the total SFOP values of the “Confidential information on OEM reproduction”, and the “Program update history” that are properties held within the “safety part”. For example, importance level setter 20 may set the maximum of the total values of the “Confidential information on OEM reproduction” and the “Program update history” as the SFOP value associated with the “safety part”. In the example shown in FIG. 2, importance level setter 20 sets the SFOP value associated with the “safety part” to “9” which is the total value of the “Confidential information on OEM reproduction”. For example, importance level setter 20 may set the SFOP value of a partition, based on another suitable statistical value, such as the median, mode, or average of the total values of the properties. Importance level setter 20 may set the sum of the maximum SFOP values as the SFOP value of a partition.

Importance level setter 20 then sets the importance level of each partition, based on the SFOP value of the partition and the table shown in FIG. 6. Since the SFOP value associated with the “safety part” is “9”, importance level setter 20 sets the importance level “5”, which is associated with the total number “9”, as the importance level of the “safety part” based on FIG. 6. In the example shown in FIGS. 2 and 6, the importance level of the “safety part” is “5”.

Importance level setter 20 sets the importance levels for the other partitions as described above.

While the maximum value of the importance level (i.e., the maximum importance level) is “5” in FIG. 6, the maximum value is not limited to five and may be two or more.

Importance level setter 20 may set the importance levels based on arrangement information (e.g., the number of stages from the entry point) on the ECUs within the on-vehicle system, instead of or in addition to the SFOP values. If there is no routine for determining the importance levels, importance level setter 20 may set the importance levels based on the implement conditions of the security measure within a partition.

Note that one importance level may be set across a plurality of physical partitions, ECUs, large-scale integrated (LSI) circuits, and logical software.

Next, referring back to FIG. 5, risk analyzing processor 30 executes the risk analyzing process, based on the design information (S30). Specifically, risk analyzing processor 30 generates the respective attack scenarios for the properties, based on the design information. The attack scenarios are generated regardless of the partitions.

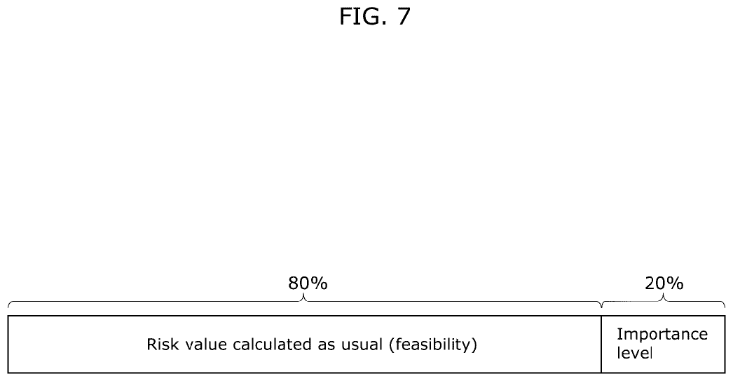

Risk value calculator 40 then calculates the risk value of each attack scenarios (S40). As described above, risk value calculator 40 may calculate the risk value of each attack scenario, based on at least one of the number of the intermediate ECUs between the entry ECU and the target ECU, the communication protocol used when the entry ECU communicates with external devices, or the presence/absence of the vulnerabilities of the ECUs on the attack path. Risk value calculator 40 may calculate the risk value further based on the importance level set by importance level setter 20. The calculation of the risk value based on the importance level will be described with reference to FIG. 7. FIG. 7 is for illustrating calculation of the risk value in view of the importance level according to this embodiment. FIG. 7 shows an example where the weight of a “Feasibility” value is 80%, and the weight of the importance level with respect to the risk value is 20%. The “Feasibility” value is the risk value calculated based on the number of ECUs described above.

Risk value calculator 40 may calculate the risk values in view of the importance levels based on following Expression 1, for example.

$$Weight of feasibility value \times feasibility value + weight of importance level \times worst risk value \times ( importance level of safety part ) / ( maximum importance level ) \qquad ( 1 )$$

For example, assume that, with respect to the attack path (i.e., the intrusion path) from “Various servers” trough “TLS for external communications” to “OTA”, the feasibility value (i.e., the value indicating the possibility to be attacked) is “8” and, as shown in FIG. 7, the ratio of the feasibility value and the importance level is 80:20, and the worst risk value (i.e., the upper limit) is “10”. In this case, risk value calculator 40 calculates the risk value by substituting these values into Expression 1. Note that the importance level of the safety part is “5” which has been determined in step S20. The maximum importance level is “5” as shown in FIG. 6.

$$0.8 \times 8 + 0.2 \times 10 \times 5 / 5 = 8.4 \qquad ( 2 )$$

In this manner, the risk value in view of the importance level is 8.4. 8.4 is the value in view of the degree of influence of the infringement.

Risk value calculator 40 may put importance on the risk value (e.g., on receipt of the information on the safety(S) and sending of the information on the privacy (P)), based on the degree (e.g., absolute value) of the difference in importance level and a predetermined rule according to SFOP attributes. That is, risk value calculator 40 may correct the calculated risk value under a predetermined rule. For example, risk value calculator 40 may correct the calculated risk value to be larger, when receiving the information on the safety(S) and sending the information on the privacy (P).

Next, referring back to FIG. 5, risk value calculator 40 determines whether a security measure is necessary, based on the risk value calculated in step S40 (S50). Risk value calculator 40 compares the risk value to a threshold set in advance, and determines that a security measure is necessary for an attack scenario with a risk value greater than or equal to a threshold.

If risk value calculator 40 determines that a security measure is necessary (Yes in S50), the process proceed to step S60. If risk value calculator 40 determines that no security measure is necessary (No in S50), the process ends.

Measures searching processor 50 calculates the difference in importance level between partitions included in each of one or more of a plurality of attack scenarios indicating a risk value that is greater than or equal to the threshold (S60). Measures searching processor 50 determines the security measure between the partitions, based on the difference in importance level between the partitions (S70). In this manner, the security measure is determined based on the risk value of the each of the one or more attack scenarios. Note that the processes in steps S60 and S70 are executed for each of the one or more attack scenarios determined to require a security measure.

The calculation of the difference in importance level and the determination on a security measure by measures searching processor 50 will be described with reference to FIG. 8. Now, communications from “User's smartphone” to “EV function” and communications from “Diagnostic equipment” to “Diagnostics” will be described.

In the communications from “User's smartphone” to “EV function”, the communication path is in the order of “User's smartphone”, “TLS for external communications”, and “EV function”. This case may have a risk of an attack in which “TLS for external communications” is spoofed, from which “EV function” receives falsified data.

To address the risk, in the communications from “User's smartphone” (i.e., an example of the “first functional section at the source”) to “TLS for external communications” (i.e., an example of the “second functional section at the destination”), measures searching processor 50 calculates the following difference (here “1”). The difference is between the importance level (i.e., an example of the “first importance level” which is here “1”) set to the external part (i.e., an example of the “first partition”) and the importance level (i.e., an example of the “second importance level” which is here “2”) set to the entry point part (i.e., an example of the “second partition”). Based on control measures policy 81 and control measures DB 91, measures searching processor 50 determines the password authentication (i.e., first password authentication), which is the detailed measure against spoofing, as the security measure. On the other hand, in the communications from “TLS for external communications” (i.e., an example of the “first functional section at the source”) to “EV function” (i.e., an example of the “second functional section at the destination”), measures searching processor 50 calculates the following difference (here “2”). The difference is between the importance level (i.e., an example of the “first importance level” which is here “2”) set to the entry point part (i.e., an example of the “first partition”) and the importance level (i.e., an example of the “second importance level” which is here “4”) set to “EV function” (i.e., an example of the “second partition”). Based on control measures policy 81 and control measures DB 91, measures searching processor 50 determines the password authentication (i.e., second password authentication), which is the detailed measure against spoofing, as the security measure. Note that the first password authentication and the second password authentication may use different passwords. For example, the password used for the second password authentication, which is the security measure between the partitions closer to the target point, may be more difficult to crack than that used for the first password authentication. Examples of the password difficult to crack may have a larger number of digits, or many types of characters including alphabet, numbers, signs, upper-case letters, and lower-case letters.

In the communications from “Diagnostic equipment” to “Diagnostics”, the communication path is the order of “Diagnostic equipment”, a “GW”, and “Diagnostics”. This case may have a risk of an attack in which “GW” is spoofed, from which “Diagnostics” receives falsified data.

To address the risk, in the communications from “Diagnostic equipment” (i.e., an example of the “first functional section at the source”) to “GW” (i.e., an example of the “second functional section at the source”), measures searching processor 50 calculates the following difference (here “1”). The difference is between the importance level (i.e., an example of the “first importance level” which is here “1”) set to the external part (i.e., an example of the “first partition”) and the importance level (i.e., an example of the “second importance level” which is here “2”) set to the entry point part (i.e., an example of the “second partition”). Based on control measures policy 81 and control measures DB 91, measures searching processor 50 determines the password authentication, which is the detailed measure against spoofing, as the security measure. On the other hand, in the communications from “GW” (i.e., an example of the “first functional section at the source”) to “Diagnostics” (i.e., an example of the “second functional section at the source”), measures searching processor 50 calculates the following difference (here “3”). The difference is between the importance level (i.e., an example of the “first importance level” which is here “2”) set to the entry point part (i.e., an example of the “first partition”) and the importance level (i.e., an example of the “second importance level” which is here “5”) set to the diagnostic (i.e., an example of the “second partition”). Based on control measures policy 81 and control measures DB 91, measures searching processor 50 determines at least one of multi-factor authentication, two-factor authentication, or face recognition, which is the detailed measure against spoofing, as the security measure. Which one of the multi-factor authentication, the two-factor authentication, and the face recognition is to be employed may be set in advance based on the combination of the functional section at the source and the functional section at the destination. For example, measures searching processor 50 may determine multi-factor authentication as the security measure.

In this manner, the determination on the security measure is executed by extracting the security measure according to the difference in importance level from control measures DB 91 including the values (e.g., the security levels) according to the differences in importance level between the partitions, and a plurality of security measures according to the values.

Note that measures searching processor 50 may put importance on the security measure to be determined (e.g., on receipt of the information on the safety(S) or the sending of the information on the privacy (P)), based on the degree (e.g., absolute value) of the difference in importance level or a predetermined rule according to the SFOP attributes. That is, measures searching processor 50 may change the determined security measure, based on the predetermined rule. For example, measures searching processor 50 may change the security level of the determined security measure to be one level higher or one level lower, based on the predetermined rule.

Note that measures searching processor 50 may determine one or more (e.g., a plurality of) security measures according to at least one of dynamic vehicle conditions or anomaly detection. For example, measures searching processor 50 may determine a larger number of security measures in the case where an (or a higher level of) anomaly or danger is determined in traveling based on at least one of the vehicle conditions or the anomaly detection than in the case where no (or a lower level of) anomaly or danger is determined in traveling based on at least one of the vehicle conditions or the anomaly detection. Examples of the former case include the cases where the vehicle is traveling at a predetermined speed or more, where there is an obstacle in the traveling path, and where an anomaly is detected in the vehicle. For example, if there is an (or a higher level of) anomaly or danger in traveling based on at least one of the vehicle conditions or the anomaly detection, measures searching processor 50 may extract at least two or more of multi-factor authentication, two-factor authentication, or face recognition, as the security measure against spoofing which is security level “2”. The vehicle conditions may include the traveling state of the vehicle (e.g., traveling or stopped), the values (e.g., the speed or the steering angle) indicated by sensors, the ambient environment (e.g., the presence of an obstacle or an oncoming vehicle). The anomaly detection represents whether an intrusion detection system (IDS) has detected an anomaly of the vehicle.

Note that the information from the devices of the external part includes the information indicating with which functional section (e.g., which ECU) the device is to communicate.

Next, output unit 60 outputs the security measure determined by measures searching processor 50 (S80). Output unit 60 may output (or mount) a plurality of security measures based on at least one of the dynamic vehicle conditions or anomaly detection.

### Other Embodiments

While the measures output method, and so on, according to one or more aspects have been described above based on the embodiment, the present disclosure is not limited to this embodiment. The present disclosure may include forms obtained by various modifications to this embodiment that can be conceived by those skilled in the art or forms achieved by freely combining the elements in different embodiments without departing from the scope and spirit of the present disclosure.

An example has been described above in the embodiment where the security measure is determined based on the difference in importance level between partitions. The determination is however not limited thereto. The security measure may be determined based on the respective importance levels of two partitions under communications. For example, the security measure may be determined based on the magnitude relation between the importance levels (i.e., an example result of comparison between the importance levels). Specifically, different security measures may be determined for the following two cases. In the first case, information is output from a partition with a relatively high importance level to a partition with a relatively low importance level. In the second case, information is output from a partition with a relatively low importance level to a partition with a relatively high importance level. In this case, a table is prepared in advance, which contains magnitude relations between the importance levels and security measures in association. For example, the security measure may be determined based on the one importance level (e.g., the higher importance level, or the importance level of the partition to which a functional section at the source or a functional section at the source belongs) determined based on the respective importance levels of two partitions. In this case, a table is prepared in advance, which contains importance levels and security measures in association.

While an example has been described above in the embodiment where importance level setter 20 sets the importance levels, the configuration is not limited thereto. The importance levels may be obtained from an external device. For example, the partition information may include information indicating the respective importance levels of the partitions. In this manner, the respective importance levels of the partitions may be obtained from an external device.

Measures output device 1 according to the embodiment described above may be employed to determine a security measure at the design stage of an on-vehicle system or to update the security measure after the mount of the on-vehicle system on the vehicle (e.g., after the sale of the vehicle). For example, the software vulnerability may change due to new discovery of the vulnerability and software updates through the OTA, for example. Measures output device 1 may thus determine (update) the security measure in the on-vehicle system after the sale of the vehicle. In this case, measures output device 1 may be mounted on a device (e.g., a server device) communicable with a vehicle, or on a vehicle.

In the embodiment described above, the table shown in FIG. 6 may be common among the partitions or may be different from partition to partition.

In measures output device 1 according to the embodiment described above, the target object on which the device is mounted or used is not necessarily a vehicle. The target object may be, for example, a flying object, such as a drone; an electronic device, such as a smartphone; or a home appliance.

In the embodiment described above, the number of the “plurality of partitions” is not particularly limited and may be two or more. The number of the functional section(s) (e.g., the ECU(s)) included in each partition is not particularly limited and may be one or more.

In the embodiment described above, the elements may be achieved by dedicated hardware or by executing software programs suitable for the elements. The elements may be achieved by a program executor, such as a CPU or a processor, reading out software programs stored in a recording medium, such as a hard disk or a semiconductor memory, and executing the read-out programs.

The order of executing the steps in the flowchart is a mere example for specifically describing the present disclosure and may be different. Part of the steps may be executed at the same time (i.e., in parallel) with another step or unexecuted.

How to divide the functional blocks in the block diagrams is an example. A plurality of functional blocks may serve as one functional block, one functional block may be divided into a plurality of parts, some functions may be transferred to another functional block. Being smaller, the functions of a plurality of functional blocks may be processed by single hardware or software in parallel or in a time-division manner.

Measures output device 1 according to the embodiment described above may be implemented as a single device or may include a plurality of devices. If measures output device 1 includes a plurality of devices, the elements of measures output device 1 may be divided into the plurality of devices in any manner. If measures output device 1 includes a plurality of devices, how the plurality of devices communicate with each other is not particularly limited, and may be wireless or wired communications. Between the devices, wireless or wired communications may be established in combination.

The elements described above in the embodiment may be achieved as software and typically as an LSI circuit. These may be individually on chips but part or all of the elements may be included on a chip. While the system LSI circuit is named here, the integrated circuit may be referred to an IC, an LSI circuit, a super LSI circuit, or an ultra-LSI circuit depending on the degree of integration. The circuit integration is not limited to the LSI. The devices may be dedicated circuits (or general-purpose circuits executing dedicated programs) or general-purpose processors. A field programmable gate array (FPGA) programmable after the manufacture of an LSI circuit or a reconfigurable processor capable of reconfiguring the connections and settings of circuit cells inside an LSI may be employed. Appearing as an alternative circuit integration technology to the LSI, another technology that progresses or deprives from the semiconductor technology may be used for integration of the elements.

The system LSI circuit is a super multifunctional LSI circuit manufactured by integrating a plurality of processors on one chip, and specifically is a computer system including a microprocessor, a ROM, and a RAM, for example. The ROM stores computer programs. The microprocessor operates in accordance with the computer programs so that the system LSI circuit fulfills its functions.

An aspect of the present disclosure may be directed to a computer program for causing a computer to execute the characteristic steps included in the measures output method shown in FIG. 5.

For example, the program may be executed by a computer. An aspect of the present disclosure may be directed to a non-transitory computer-readable recording medium having such a program recorded thereon. For example, such a program may be recorded in a recording medium and distributed. For example, the distributed program is installed in a device including another processor and executed by the processor so that the device can perform the processing.

### REMARKS

The description of the embodiment described above discloses the following techniques.

### Technique 1

A measures output method is to be executed by a computer. The measures output method includes: obtaining respective importance levels of a plurality of partitions for separating a plurality of functional sections to be mounted on a vehicle, the plurality of partitions including a first partition to which a first functional section at a source belongs, and a second partition to which a second functional section at a destination belongs; determining a security measure for a communication from the first functional section to the second functional section based on a first importance level of the first partition and a second importance level of the second partition; and outputting information on the security measure determined.

This configuration can determine the security measure based on the importance levels of the two partitions at the source and the destination, and can thus determine a more suitable security measure in the communications as compared to the case of determining a security measure based on one importance level. This configuration can determine the security measure assuming unauthorized intrusion, based on the importance levels between the partitions, and can thus determine a more suitable security measure in case of unauthorized intrusion.

### Technique 2

In the measures output method according to Technique 1, the determining of the security measure is executed based on a difference between the first importance level and the second importance level.

This configuration can determine a more suitable security measure in accordance with the difference in importance level.

### Technique 3

In the measures output method according to Technique 2, the determining of the security measure is executed by extracting a security measure according to the difference between the first importance level and the second importance level, from a control measures database containing: a plurality of values according to differences in importance level between the plurality of partitions; and a plurality of security measures according to the plurality of values.

This configuration can determine the security measure in the control measures DB according to the difference in importance level as a more suitable security measure.

### Technique 4

In the measures output method according to Technique 3, the plurality of values according to the differences in importance level represent security levels. The determining of the security measure is executed under a control measures policy indicating a correspondence between the security levels and the differences in importance level.

This configuration can determine a more suitable security measure in view of improving the security level.

### Technique 5

In the measures output method according to Technique 4, the control measures policy includes that a second value has a security level higher than a security level of a first value, when the difference is the second value that is greater than the first value.

This configuration determines a security measure with a higher security level in communications with a partition holding a property that can be relatively largely influenced by infringement, and can thus improve the security of the on-vehicle system effectively.

### Technique 6

In the measures output method according to Technique 5, the control measures policy includes that password authentication is associated with the security level of the first value, and that at least one of multi-factor authentication, two-factor authentication, or face recognition is associated with the security level of the second value.

This configuration can determine a more suitable security measure against spoofing.

### Technique 7

In the measures output method according to Technique 5, the control measures policy includes that use of a signature using RSA encryption or elliptic curve cryptography is associated with the security level of the first value, and that use of a signature using post-quantum cryptography (PQC) is associated with the security level of the second value.

This configuration can determine a more suitable security measure against falsification.

### Technique 8

In the measures output method according to any one of Techniques 1 to 7, the obtaining of the respective importance levels is executed by setting the respective importance levels of the plurality of partitions based on detailed properties held by one or more of the plurality of functional sections belonging to the plurality of partitions.

This configuration can set the importance levels automatically.

### Technique 9

The measures output method according to Technique 8 further includes: obtaining design information including a connection relation of the plurality of functional sections; generating a plurality of attack scenarios based on the design information; and calculating respective risk values in the plurality of attack scenarios. The determining of the security measure is executed based on the respective risk values in the plurality of attack scenarios.

This configuration further employs the respective risk values in the plurality of attack scenarios, and can thus determine more suitable security measures in view of the risk values.

### Technique 10

In the measures output method according to Technique 9, the calculating of the respective risk values in the plurality of attack scenarios employs, in each of the attack scenarios, an importance level of at least one of the one or more of the plurality of partitions to which one or more of the plurality of functional sections belong.

This configuration can calculate the risk values in view of the influence of the infringement when being attacked, in addition to the possibility of attack. That is, the configuration can calculate more suitable risk values in view of the influence of the infringement. Based on such risk values, more suitable security measures can be determined.

### Technique 11

In the measures output method according to Technique 9 or 10, determining of the security measure is executed for each of one or more of the plurality of attack scenarios whose risk value calculated is greater than or equal to a threshold.

This configuration determines the security measures only for the attack scenarios with greater risk values, and can thus reduce the amount processing information required for determining the security measures.

### Technique 12

A measures output device includes: an obtainer that obtains respective importance levels of a plurality of partitions for separating a plurality of functional sections to be mounted on a vehicle, the plurality of partitions including a first partition to which a first functional section at a source belongs, and a second partition to which a second functional section at a destination belongs; a determiner that determines a security measure for a communication from the first functional section to the second functional section based on a first importance level of the first partition and a second importance level of the second partition; and an output unit that outputs information on the security measure determined.

This configuration provides at least the same advantages as the measures output method described above.

### Technique 13

A recording medium is a non-transitory computer-readable recording medium having recorded thereon a program for causing a computer to execute the measures output method according to any one of Techniques 1 to 11.

This provides at least the same advantages as the measures output method described above.

Note that these general and specific aspects of the present disclosure may be implemented using a system, a method, an integrated circuit, a computer program, or a computer-readable on-volatile recording medium, such as a CD-ROM, or any combination of systems, methods, integrated circuits, computer programs, or recording media. The program may be stored in advance in a recording medium or may be supplied to a recording medium through a wide-area communication network, such as the Internet.

### Further Information About Technical Background to This Application

The disclosure of the following patent application including specification, drawings, and claims is incorporated herein by reference in its entirety: Japanese Patent Application No. 2024-191218 filed on Oct. 30, 2024.

### INDUSTRIAL APPLICABILITY

The present disclosure is useful for an information processor, for example, for outputting a security measure to a target.

1. A measures output method to be executed by a computer, the measures output method comprising:
obtaining respective importance levels of a plurality of partitions for separating a plurality of functional sections to be mounted on a vehicle, the plurality of partitions including a first partition to which a first functional section at a source belongs, and a second partition to which a second functional section at a destination belongs;
determining a security measure for a communication from the first functional section to the second functional section based on a first importance level of the first partition and a second importance level of the second partition; and
outputting information on the security measure determined.

2. The measures output method according to claim 1, wherein
the determining of the security measure is executed based on a difference between the first importance level and the second importance level.

3. The measures output method according to claim 2, wherein
the determining of the security measure is executed by extracting a security measure according to the difference between the first importance level and the second importance level, from a control measures database containing: a plurality of values according to differences in importance level between the plurality of partitions; and a plurality of security measures according to the plurality of values.

4. The measures output method according to claim 3, wherein
the plurality of values according to the differences in importance level represent security levels, and
the determining of the security measure is executed under a control measures policy indicating a correspondence between the security levels and the differences in importance level.

5. The measures output method according to claim 4, wherein
the control measures policy includes that a second value has a security level higher than a security level of a first value, when the difference is the second value that is greater than the first value.

6. The measures output method according to claim 5, wherein
the control measures policy includes that password authentication is associated with the security level of the first value, and that at least one of multi-factor authentication, two-factor authentication, or face recognition is associated with the security level of the second value.

7. The measures output method according to claim 5, wherein
the control measures policy includes that use of a signature using RSA encryption or elliptic curve cryptography is associated with the security level of the first value, and that use of a signature using post-quantum cryptography (PQC) is associated with the security level of the second value.

8. The measures output method according to claim 1, wherein
the obtaining of the respective importance levels is executed by setting the respective importance levels of the plurality of partitions based on detailed properties held by one or more of the plurality of functional sections belonging to the plurality of partitions.

9. The measures output method according to claim 8, further comprising:
obtaining design information including a connection relation of the plurality of functional sections;
generating a plurality of attack scenarios based on the design information; and
calculating respective risk values in the plurality of attack scenarios, wherein
the determining of the security measure is executed based on the respective risk values in the plurality of attack scenarios.

10. The measures output method according to claim 9, wherein
the calculating of the respective risk values in the plurality of attack scenarios employs, in each of the attack scenarios, an importance level of at least one of the one or more of the plurality of partitions to which one or more of the plurality of functional sections belong.

11. The measures output method according to claim 9, wherein
determining of the security measure is executed for each of one or more of the plurality of attack scenarios whose risk value calculated is greater than or equal to a threshold.

12. A measures output device comprising:
an obtainer that obtains respective importance levels of a plurality of partitions for separating a plurality of functional sections to be mounted on a vehicle, the plurality of partitions including a first partition to which a first functional section at a source belongs, and a second partition to which a second functional section at a destination belongs;
a determiner that determines a security measure for a communication from the first functional section to the second functional section based on a first importance level of the first partition and a second importance level of the second partition; and
an output unit that outputs information on the security measure determined.

13. A non-transitory computer-readable recording medium having recorded thereon a program for causing a computer to execute the measures output method according to claim 1.
